(19) United States
(12) Patent Application Publication
(10) Pub. No.: US 2009/0265661 A1
(43) Pub. Date: Oct. 22, 2009

(54) MULTI-RESOLUTION THREE-DIMENSIONAL ENVIRONMENT DISPLAY

(76) Inventor: Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 12/423,250

(22) Filed: Apr. 14, 2009

Related U.S. Application Data
(60) Provisional application No. 61/044,781, filed on Apr. 14, 2008.

(51) Int. Cl. G06F 3/048

(52) U.S. Cl. 715/797

(57) ABSTRACT

A computer manages display of objects having different resolution values in a coordinated multi-player game process. One or more servers and client applications operate cooperatively to manage and display various different resolution areas representing output from the unitary game process. The server receives input data from a plurality of clients and outputs game state data to participating clients. One or more objects in the game environment may be designated for display at different resolutions than other objects in the game environment. Alternatively, objects appearing within a defined screen area may be displayed at a different resolution from whatever does not appear within the defined screen area. One or more servers transmit data to the participating client defining different display resolutions for different objects or screen areas. The game environment may be configured with transparent areas to reveal a window of the objects having different display resolution underneath.

### CROSS-REFERENCE TO RELATED APPLICATIONS

This application claims priority pursuant to 35 U.S.C. § 119(e) to U.S. provisional application Ser. No. 61/044,781, filed Apr. 14, 2008, which is hereby incorporated by reference, in its entirety.

### BACKGROUND

1. Field

The present disclosure relates to an apparatus and method for providing and managing various different display resolution areas in a computer environment.

2. Description of the Related Art

Virtual and other computerized environments, especially when served to multiple remote clients participating in a multi-node process, may be displayed in limited resolution due to constraints on computing power, graphics processing, memory, bandwidth and many other performance and operational reasons. Typically there is a tradeoff between performance, such as the frame rate or the number of avatars that may be simultaneously rendered, and resolution, such as the number of pixels displayed and color depth. Existing art forces this tradeoff. For example, it is common for a 640×480 video game to be displayed at full-screen resolution using pixel doubling or some other method, where each pixel is simply replicated one or more times in order to fill the screen without increasing the resolution that the video game must render. At this resolution level, it may not be possible to legibly display certain information.

A virtual conference hall holding a convention with numerous attendees provides an example. Within the conference hall, an attendee meets several colleagues and wishes to show them an article from the Wall Street Journal. Although all of the participants have a monitor capable of displaying the large portions of the article at a time an easily readable resolution, the software and hardware rendering the virtual environment have limited the resolution to 640×480. As such, it is impractical to render the article within the game environment and a new window must be opened in order to render the article at a reasonable resolution. Such an external application simultaneously destroys the verisimilitude of the game and impairs the ability of participants to interact with the article, such as by pointing the hands of their avatars at particular sections.

Therefore, it would be desirable to provide a method or system for providing and managing various different resolution areas in a game environment, that overcomes these and other limitations of the prior art.

### SUMMARY

Accordingly, the present system, apparatus and method achieves managing various different resolution areas within a computer display.

In accordance with the present disclosure, there is provided a method and system useful in reducing or eliminating the performance cost of true high resolution display of elements within a computerized environment in which multiple clients are communicating via a server. The server receives inputs from each client participating in a game or process, processes the inputs to determine successive game or process states, and transmits the game or process states in succession to the participating clients. Each client receives the state information and uses the information to render animated views of the game or other process. The state information may comprise numerous graphic elements, for example, graphic textures or rendered objects, provided at a defined resolution. When rendered and displayed at clients running higher resolution display environments, the game or process may be displayed in a reduced size window. In the alternative, the game or process may be increased to full screen or to a larger window size by pixel doubling or some other method not requiring rendering of additional pixels. When it is desired to display a rendered object at a higher resolution than is possible using the clients' rendering engines without some noticeable degradation of rendering speed, the server may identify a relatively small portion of state information as requiring a higher resolution display. For example, the server may identify the high-resolution object itself or demarcate a limited screen area less than the entire screen area within which the higher resolution object is to be rendered.

After the process state data is received by the client, the presence of the demarcated screen area or object may be detected by the client and trigger a special application or module, for example, a plug-in module, to directly render the higher resolution object in a window positioned on top of a first window displaying the game or process at normal resolution. The server may transmit information defining the bounds of the high-resolution object and how it is scaled for each participant to each client. Each client can thereby determine what portion a user is pointing to with their avatar, for example, and may communicate that to other software clients. Optionally, applications operating at each client may communicate through the server (or via the game and then through the server) to keep the actual data (or parameters thereof the same for all viewers, downscaling where appropriate to match the amounts displayed on higher resolution monitors to the amounts displayed on lower resolution monitors of other participants. Operationally, a lower bound of resolution may be set, below which participation may be denied.

In the alternative, or in addition, process state information provided by the server to clients for rendering the game process in a first window may contain a color code that is rendered as transparent by the client operating system's or hardware's rendering device. A higher resolution data source, such as a second application or module operating at the client, may then display content below first window, with a transparent portion of the first window positioned to provide a viewing window for the underlying higher resolution content. One benefit of this mechanism is that full integration with a plug-in is not necessary. However, the benefits described in the demarcated approach above may be integrated with the transparent window approach as well. Without full integration, for example, a legacy application (such as a web browser) may be positioned by the game software in a specific place below first window, and portions of the first window made opaque to prevent undesired features of the data (for example a web browser menu bar) from being visible in the first window.

In accordance with one aspect, systems and methods are provided for generating a multi-player game environment with one or more objects in various different resolutions. At least one host server may be configured to communicate with a plurality of network clients. The host server may comprise at least a first memory holding instructions configured for receiving input data from one or more network clients. The input data from each client may comprise a request to display at each respective client, one or more objects in a game environment at a resolution that is different from that of the game environment. The first memory may further hold instructions configured for analyzing the input data to determine display limits of the one or more objects, communicating the display limits of the one or more objects to an applications server and causing one or more transparent windows in the game environment to be rendered at the client, the one or more transparent windows configured to permit the display of the one or more objects in the game environment.

At least one application server may be configured to communicate with the one host server and the plurality of network clients. The application server may comprise a second memory holding instructions configured for receiving display limits associated with the one or more objects; rendering the one or more objects according to the associated display limits; and causing the rendered one or more objects to be displayed at the client terminal in connection with the game environment. The one or more objects may have a resolution that is different from that of the game environment.

Each user participates in the game environment through a network client. The client may comprise a processor operatively associated with random-access memory for holding processor instructions and input data. The processor may also be in communication with a storage device, including a tangible computer-readable medium, for storing software and data for use in operating the processor.

Other components of the client may include a network interface enabling the processor to communicate with networked servers; a display screen and/or speaker for providing visible and/or audible output to the user, and an input device, for example, a keyboard, touch screen, pointing device, and/or microphone for receiving tactile and/or audible input. All of the foregoing components may be housed in housing configured in any suitable form factor. For example, the client may be provided in a portable, hand-held form, such as in a palm-top computer or intelligent mobile phone. In the alternative, the client may be provided in the form of a laptop or desktop computer. The client may thus be equipped to transform tactile or audible input into an interactive game environment.

Input data entered through the client may be stored in a computer-readable medium and represents a transformation of the tactile and/or audible input received by the client into the form of electronic data and into audible or visible output representing that data. Further transformation of the data may occur when the input data is transmitted to a host server. The message may be transferred to and recorded in different storage medium, such as to a storage medium for a host server. The input data may be used to generate display limits for objects within the game environment. Eventually, the objects will be provided for visual display at the respective client terminals. These transformations are generally essential to the function and purpose of the multi-player game environment as a system designed to interact with people.

### BRIEF DESCRIPTION OF THE DRAWINGS

FIG. 1 is a flow diagram showing exemplary steps of a method of managing various different resolution areas within a computer display.

FIG. 2 is a block diagram illustrating a system of managing various different resolution areas within a computer display.

FIG. 3 is a block diagram showing other exemplary details of a system for providing different resolution displays of different objects appearing in a unitary game process.

In the detailed description that follows, like element numerals are used to describe like elements appearing in one or more of the figures.

### DETAILED DESCRIPTION OF THE EMBODIMENTS

A more complete appreciation of the disclosure and many of the attendant advantages will be readily obtained, as the same becomes better understood by reference to the following detailed description of the exemplary embodiments.

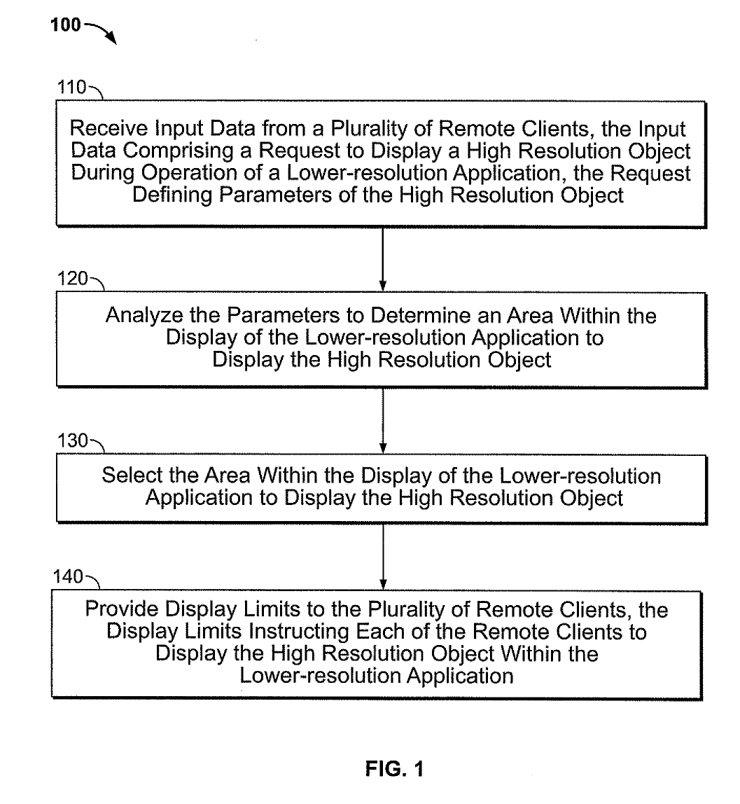

FIG. 1 is a flow diagram showing exemplary steps of a method 100 of managing various different resolution areas within a computer display. At step 110, the method 100 receives input data from a plurality of remote clients. The input data comprises a request to display a high resolution object during operation of a lower-resolution application. The request defines parameters of the high resolution object. The request may comprise the size, shape, number of pixels, arrangement of pixels, the type of media and other parameters of the high resolution object. The request may be sent from an authorized one of the remote clients, a network server or any other authorized data source desiring to display high resolution objects.

At step 120, the method 100 analyzes the parameters to determine an area within the display of the lower-resolution application to display the high resolution object. The area may be determined from the parameters themselves, or may be determined by the method 100. At step 130, the method 100 selects the area within the display of the lower-resolution application to display the high resolution object.

At step 140, the method 100 provides display limits to the plurality of remote clients. The display limits instruct each of the remote clients to display the high resolution object within the lower-resolution application. The method 100 may be modified to include more than one high resolution object. Plug-in applications may communicate with a server to coordinate the display limits between the remote clients, so that each of the remote clients displays the high resolution object according to its perspective. Alternatively, the computer may contain a color code that is rendered as transparent by the computer's rendering device. A plug-in application may then display the high resolution content in a viewing window below the lower-resolution application's display. The method 100 may use a database server and database to store any of the high resolution object's parameters or other data associated with the lower-resolution application.

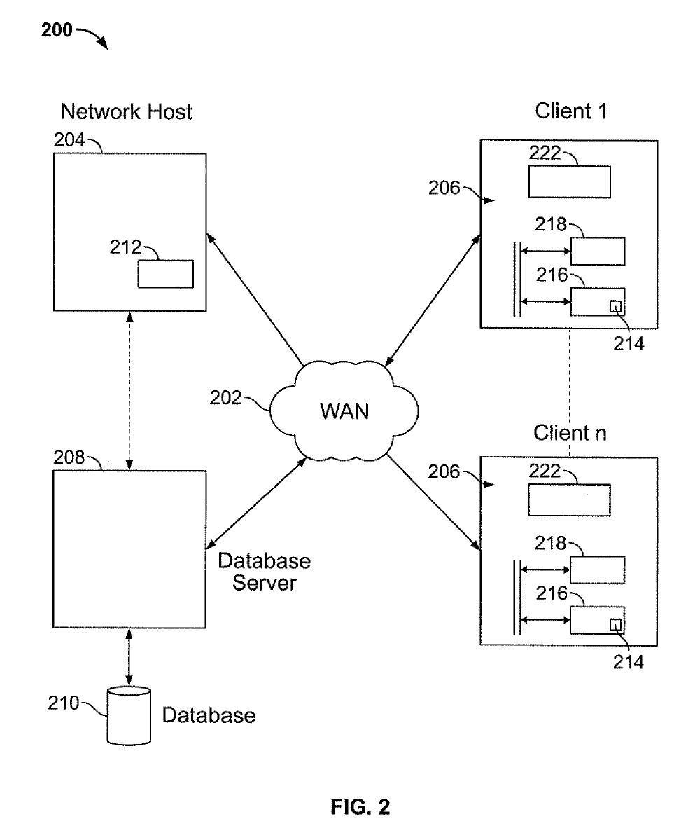

FIG. 2 is a block diagram illustrating a system 200 of managing various different resolution areas within a computer display in accordance with the present disclosure. In an aspect, the system 200 may comprise a Wide Area Network (WAN) 202, network host computer 204, a plurality of clients 206, a database server 208 and a database 210. The WAN may enable connectivity between the network host computer 204, the plurality of clients 206, the database server 208 and the database 210. The network host computer 204 may comprise a display application 212, which may be encoded on a computer-readable medium, for example, an optical, magnetic, or electronic medium, and configured for performing steps illustrated in the flow diagram of FIG. 1. Alternatively, each of the plurality of clients 206 may comprise a display program 214, which may also be encoded on a computer-readable medium and configured for performing the steps illustrated in the flowchart of FIG. 1. In yet another alternative, some of the steps illustrated in the flowchart of FIG. 1 may be performed by the display application 212 and some of the steps illustrated in the flowchart of FIG. 1 may be performed by the display program 214. The database server 208 and attached database 210 may be coupled to the network host computer 204 to store the database entries used in the method illustrated in the flowchart of FIG. 1. Alternatively, the database server 208 and/or database 210 may be connected to the WAN 202 and may be operable to be accessed by the network host computer 204 via the WAN 202.

An operator of client 206 may provide input to the system via a computer interface device, for example, a keyboard, pointing device, microphone, or some combination of the foregoing. The input may include parameter information relevant to one or more objects to be displayed at a higher resolution. For example, the operator of client 206 may use a pointing device, such as a mouse, to select one or more objects in the game environment for viewing at higher resolution. This input may be transmitted to the host server as a request to display the selected object at the higher resolution. System outputs may include the requested object displayed at the higher resolution at the respective client terminals viewing the same game environment, but at each respective client's perspective. The perspective may be determined in response to user input, permitting each user to enjoy a personal experience of the game environment. System 200, when used to perform the methods described herein, operates to transform input received at client 204 into a tangible output, namely an audio-video display responsive to user input.

The plurality of clients 206 may further comprise an internal hard disk 216 for storing the display program 214, a processor 218 for executing the display program 214 and/or performing other background tasks and an internal bus 220 for internally connecting the hard disk 216 and the processor 218. The hard disk 216 may also be configured to store the high resolution object parameters and/or data associated with the lower-resolution application used in the method illustrated in the flowchart of FIG. 1. The output of the method illustrated by the flowchart of FIG. 1, the display limits, may be used to display the completely rendered display on the plurality of clients 206 via a display 222 in accordance with the matching email parameters. A plug-in application may be used to facilitate the completely rendered display.

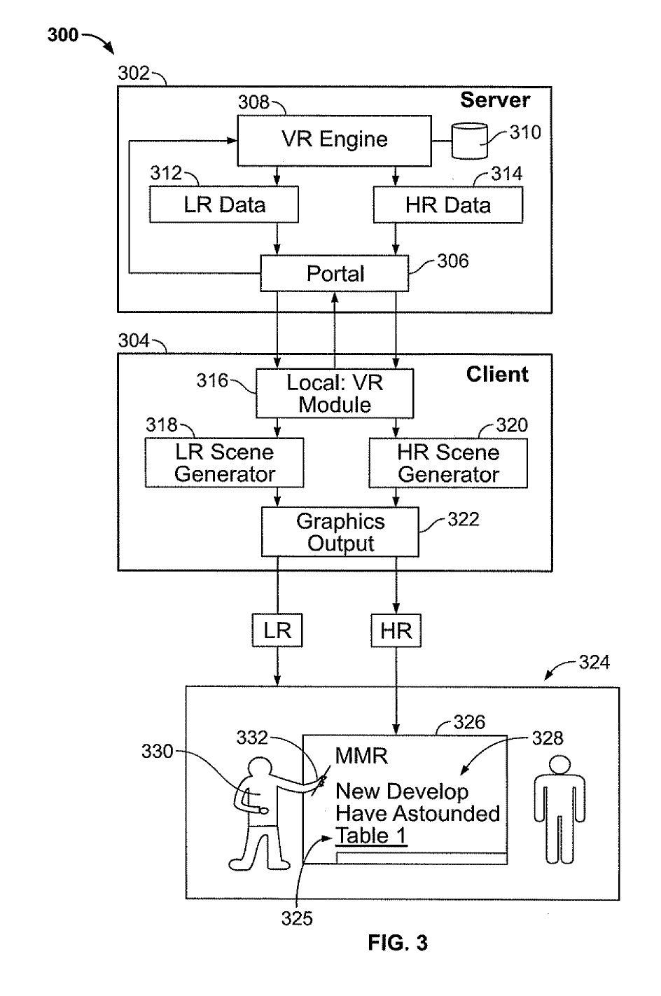

FIG. 3 is a block diagram showing other exemplary details of a system 300 for providing different resolution displays of different objects appearing in a unitary game process coordinated by a central server 302 in communication with multiple remote clients 304 (one of many shown). Each remote client interfaces with a user (not shown) providing input to the game process via an input device such as a mouse, keyboard, etc. The server 302 may send and receive game data via a portal module 306. Data from multiple remote clients is provided to a server-side virtual reality (“VR”) engine 308 that processes input data to determine successive game states. Each game state represents positions of modeled objects in a three-dimensional environment. Modeled objects may be two or three dimensional objects, or a combination thereof. Accordingly, objects have defined geometrical boundaries in the modeled space.

Objects are associated with object properties stored in a game database 310. One of the object properties may include a preferred display resolution. Two dimensional objects, such as flat areas on a modeled wall or other flat surface, may be particularly appropriate for designating for higher resolution display. For example, a flat area within a three-dimensional modeled environment may display text, photographs, or video at a higher resolution than surrounding objects. Three-dimensional objects, or portions of them, may also be designated as higher (or lower) resolution. For example, it may be desirable to display facial features at a higher resolution than other body parts. Resolution may vary depending on external parameters such as, for example, time-of-day or available server bandwidth.

The VR Engine 308 may provide game state data including object data (e.g., position) for objects to be displayed at different display resolutions. For example, game state data may comprise state data for low or normal resolution objects (“LR” data 312) and for higher resolution objects (“HR” data 314). The LR and HR data includes sufficient information to define a boundary between higher and lower resolution areas for the game, for each successive game state communicated from the server 302 to client 304.

Client 304 may receive the LR and HR data at a local VR module or application running on the client 304. The local VR application may function to receive user inputs and transmit data to the server, receive game state data from the server, and generate an animated graphic output of the game environment in response to the changing game state data received from the server. As part of generating an animated graphic output, the local VR application may use a locally-defined viewpoint to render views of successive frames of a modeled scene, responsive to the game data. When the modeled scene contains objects or areas designated for display at different resolutions, the client may use a special application, module, or integrated code to define and track a boundary between different resolution areas as relevant to the local-defined viewpoint. These boundaries may be complex or simple, static between frames or changing between frames. For example, in the simple case of a rectangular flat stationary object designated as high-resolution, and a static viewpoint, the high-resolution area boundary may be a defined rectangle corresponding to a static screen area. If the local viewpoint shifts, the shape and position of the high resolution area may change also.

In whatever fashion the boundary is defined, the client may generate low resolution scene data for graphics output in a first process 318, and high resolution scene data for graphics output in a second process 320. The different HR and LR data may be integrated for graphics output 322 as a VGA or video signal for a display device.

For example, first, or low, resolution data may be provided for a foreground window 324 of a graphics display. The foreground window may have a transparent portion 325 having a shape and position that exactly corresponds to the shape and position of a second (higher) resolution object as it would appear from the local viewpoint. The transparent portion may be 100% transparent inside of a boundary 328, or may allow for intrusion of non-transparent objects. For example, a portion of a hand 332 belonging to a modeled body in the foreground window may be rendered as opaque if the hand 332 is positioned between the local viewpoint and the higher resolution object. Higher resolution data may be provided in an underlying window 328 positioned below and aligned with the transparent portion 325 of the foreground window. Thus, the higher-resolution object appears as if in a unitary window with the objects rendered in the foreground window. In addition, objects in both windows are part of a unitary game process and thus can be made to appear to interact with each other although rendered and displayed at different resolutions.

The foregoing example, using foreground and background systems, may be useful for computer operating systems with graphical windowing capabilities. Other technical solutions may also be used with the game system displaying objects at different resolutions in a unitary game process. The present technology is not limited to a particular display method.

Having thus described embodiments of a method and system for managing various different resolution areas within a computer display, it should be apparent to those skilled in the art that certain advantages of the within system have been achieved. It should also be appreciated that various modifications, adaptations, and alternative embodiments thereof may be made within the scope and spirit of the present invention. For example, a system operable over a wide area network has been illustrated, but it should be apparent that the inventive concepts described above would be equally applicable to systems operating over other networks. Numerous modifications and variations of the disclosure are possible in light of the above disclosure. The claimed subject matter is defined by the appended claims.

What is claimed is:

1. A method comprising:
processing, at a host server, input data from one or more clients to define a modeled environment of a multi-user process responsive to the input data, the modeled environment comprising information for display in at least two different display resolutions;
configuring the modeled environment for display in at least two separate overlapping windows at each client, wherein a first portion of the modeled environment is designated for display at a first display resolution in a first one of the at least two separate overlapping windows and a second portion of the modeled environment is designated for display at a second display resolution different from the first display resolution in a second one of the at least two separate overlapping windows, and the at least two overlapping windows are coordinated to provide an integrated display of the modeled environment; and
serving the modeled environment to the clients for providing a display output responsive to input.

2. The method of claim 1, further comprising defining, at the host server, at least one geometric shape for distinguishing the first portion of the modeled environment from the second portion of the modeled environment.

3. The method of claim 1, further comprising designating, at the host server, at least one modeled object as belonging to the first portion of the modeled environment.

4. The method of claim 1, further comprising configuring the first portion of the modeled environment for display in the first one of the at least two separate overlapping windows having a transparent region overlapping and revealing the second one of the at least two separate overlapping windows.

5. The method of claim 4, wherein the transparent region is defined by a boundary calculated at the server.

6. The method of claim 4, wherein server provides information to each client for calculating boundaries of the transparent region depending on a user-selected viewpoint for each client.

7. The method of claim 4, further comprising selecting a shape for the transparent region to reveal only a particular modeled three-dimensional object appearing in the second one of the at least two separate overlapping windows.

8. The method of claim 1, further comprising configuring the modeled environment as successive frames of an animated display.

9. The method of claim 1, wherein the at least two separate overlapping windows are substantially free of any transparent region.

10. A method comprising:
receiving, from a host server, information defining different display resolutions for one or more objects and a modeled environment to be displayed at a client, the information responsive to input received at the client;
rendering the one or more objects at the client to display an image of the one or more objects at a first display resolution;
rendering the modeled environment at the client to display an image of the modeled environment at a second display resolution that is different from the first display resolution; and
displaying the one or more objects and the modeled environment at the client so that the one or more objects appear to be a part of the modeled environment while being displayed at a different resolution from the modeled environment.

11. The method of claim 10, further comprising displaying the one of more objects in a first window and the modeled environment in a second window.

12. The method of claim 11, further comprising arranging the first and second windows so that the first window covers a portion of the second window.

13. The method of claim 11, further comprising arranging the first and second windows so that the second window overlays the first window, at least a portion of which is revealed through a transparent portion of the second window.

14. The method of claim 10, further comprising receiving input at an input device in communication with the client, and transforming the input into input data for providing to the host server.

15. The method of claim 10, further comprising displaying the one or more objects and the modeled environment in successive frames of an animated display.

16. The method of claim 15, further comprising determining a boundary between display areas for the first and second display resolutions for different successive frames of the animated display.

17. The method of claim 16, further comprising determining the boundary based on a viewpoint that is determined in response to input received from a user input device in communication with the client.

18. The method of claim 11, wherein the first window and the second window are substantially free of any transparent region, and the first window overlies at least a portion of the second window.

19. A tangible computer-readable medium having stored thereon, computer-executable instructions that, if executed by a computing device, cause the computing device to perform a method comprising:
receiving input data from a plurality of clients for controlling one or more animated objects in a multiuser process;
processing the input data to determine state information defining a current state of a game including objects to be displayed at different display resolutions;
serving the state information to the plurality of clients configured to cause a first window comprising opaque and transparent portions to be rendered at the client, the opaque portion configured to display a game environment at a first display resolution and the transparent portion configured to reveal at least one object in the game at a second display resolution different from the first display resolution.

20. A tangible computer-readable medium having stored thereon, computer-executable instructions that, if executed by a computing device, cause the computing device to perform a method comprising:
receiving input from an input device transforming physical input into data;
providing the input to a server for use in a multi-user process that responds to input from multiple clients;
receiving process information from the server defining a current game state in response to the input; and
displaying a first window comprising opaque and transparent portions, the opaque portion configured to display the current game state at a first display resolution and the transparent portion configured to reveal at least one object in the game at a second display resolution different from the first display resolution.
